(19) United States
(12) Patent Application Publication
(10) Pub. No.: US 2012/0188395 A1
(43) Pub. Date: Jul. 26, 2012

(54) Editing and Annotating Digital Camera

(76) Inventor: Jennifer Barber, Philadelphia, PA (US)

(21) Appl. No.: 13/343,410

(22) Filed: Jan. 4, 2012

Related U.S. Application Data
(60) Provisional application No. 61/434,653, filed on Jan. 20, 2011.

(51) Int. Cl. H04N 5/228

(52) U.S. Cl. 348/222.1; 348/E05.031

(57) ABSTRACT

A digital image-taking device designed to allow a practitioner to edit recently taken photographs, as well as a method for doing so. The device takes digital photographs and stores them in the internal memory, from which they may be recalled for editing. The device is equipped with an LCD display screen that slides upward to reveal a keyboard, cursor controls and editing buttons, which may be used to manipulate images currently stored on the internal memory of the device. In particular, the editing controls are designed to facilitate the branding and annotating of photographs to allow the practitioner to maintain a proper memory of who, what, where and when the photograph was taken. The device is equipped with a variety of software editing tools, and may include a touch screen to facilitate usage.

### CROSS REFERENCE TO RELATED APPLICATION

This application claims the benefit of U.S. Provisional Application No. 61/434,653 filed on Jan. 20, 2011, entitled “Memory Camera.”

### BACKGROUND OF THE INVENTION

1. Field of the Invention

The present invention relates to a digital image-taking device. More specifically, the present invention relates to an image-taking device further capable of branding, editing and transferring stored images.

Cameras often capture important and unique moments during holidays, special occasions, and trips in order for individuals to maintain memories. With the advent of digital cameras, individuals have become less limited by the cost associated with traditional film and frequently take numerous pictures. Of particular concern are users forgetting the details or memories they wished to associate with the picture. This may be especially true when individuals visit foreign locations, as the unfamiliar surroundings can make the photographs and individuals therein difficult to identify. Practitioners, particularly those who take a large number of pictures, would find it useful to have a means to edit pictures as they are taken, and more particularly, to brand the photos with text information to assist remembering the locations, people and events depicted therein.

A digital camera can take a photograph without using conventional film and then store the photo in digital form on a memory card. With recent advances in technology, the size of memory cards has greatly increased. The increase in size and decrease in cost has occurred much faster than increases in the size of pictures, such that the user can take an excessively large quantity of photographs before exhausting the available memory. Storage capacity is limited only by the size of the memory card. Further once taken, digital photos can be printed to paper, allowing the user to retain a tangible memory. However, a conventional digital camera does index, caption or provide descriptions on the photos, such that following printing from the memory card, the user may not recall the specific time and location depicted.

A means for editing and inputting alphanumeric information onto the stored digital photos within a camera is needed. Currently there are electronic devices that use a variety of means for inputting of alphanumeric information onto digital media. Depending on the type of device and its characteristics (e.g., size, type of display, intended use, and the like), some input means are more advantageous than others. For example, some devices lend themselves to the incorporation of miniature keyboards (e.g., a Smartphone), while other types of devices require alternative alphanumeric input means (e.g., a traditional cellular phone). Other devices include LCD touch screen displays or make use of a stylus.

However, in the case of a typical digital camera, there is currently no sufficiently simple, intuitive way for a user to enter substantial amounts of text directly into the camera. While the incorporation of an LCD screen allows the digital camera to be easily controlled and manipulated, and provides an intuitive, easily used method for displaying device status, operating mode, stored images, etc. to the user, the small size of the LCD poses limits to its utility with regard to entering text or editing photos. In addition to the small LCD size, the available area on the body of the digital camera that can be used for inclusion of buttons, switches, mode dials, etc. is extremely limited. Further complicating the size issue, digital cameras must also include a number of buttons, switches and dials for configuring the operating modes of the camera, navigating between images in play mode and the like. For example, most digital cameras include buttons (e.g., two buttons labeled “−” and “+”) that enable a user to navigate or scroll through captured images. One or more of the buttons can be implemented as software programmable buttons (e.g., “soft keys”). While this type of interface is very efficient at interfacing the user with the capabilities of the digital camera, it has proven to be very cumbersome when used to enter text or perform other edits to the images stored in the camera. Thus, there is need for an efficient means of text input that does not require the sacrifice of already limited space on the body of the camera.

The incorporation of a keyboard onto the digital camera would provide a substantial improvement in functional convenience. A keyboard can increase usability and speed by eliminating a manual input augmentation device, such as a stylus or wheel, while the required display of user interface is minimized. However, the inclusion of a keyboard has not been accomplished in a manner that provides a usable keyboard without requiring a great increase in the size of the digital camera. Current digital camera users typically prefer smaller, more compact devices and are generally unwilling to sacrifice size for the inclusion of a keyboard.

Further, the practitioner may desire the ability to otherwise modify or edit pictures as they are taken and stored, thus requiring the ability to make additional edits beyond simple branding. For example, Often photographs are taken in which the desired subject represents only a small portion of the photograph. In such a situation, other editing functions such as the ability to crop would be useful. The inclusion of advanced editing functions such as cropping, applying filters, altering colors, shading, or any other type of manipulation could be extremely useful to the practitioner. Such functions would require the inclusion of a pointing device such as a cursor and control means for effective application.

There is currently a need in the art for a device that allows the practitioner to edit, and more particularly to brand photos with alphanumeric text immediately following the taking of the photos. Such a device should allow the user to take pictures with a variety of settings, as well as brand, label, crop and perform other editing operations on the photos while stored in the memory of the device. There remains a need for quality imaging, rapid and efficient text entry and efficient management and editing of images. The present invention fulfills these needs.

2. Description of the Prior Art

A variety of prior devices have attempted to address the needs of users to label and edit digital photos as they are taken. Several published applications and granted patents address these issues in a manner similar to those of the present invention, however, these prior art devices have several known drawbacks.

Devices designed with the simple addition of a keyboard fail to take into account the desire for a small device. McCurdy, U.S. Patent Publication No. 2004/0114044 is directed to a digital camera is equipped with a wireless modem for wireless image transfer, a keyboard for text input, a display screen and a screen navigation element. The screen navigation element provides for efficient selection of functions, including camera functions and the transmission of images, as well as for text entry and remote file management. The camera is designed with an identification mechanism at the MAC layer that allows the device to be uniquely identified within a network, allowing for easy wireless transfer of the images.

The McCurdy invention fails to address the need for compact size. The addition of the miniature QVWERTY keyboard or graphically depicting all of the keys of the keyboard within the limited size of a touch screen makes the individual keys of the keyboard quite small or requires a significant investment of space. This leads to problems wherein the user inadvertently selects the incorrect alphanumeric character or selects multiple characters at the same time. The placement of the keyboard beneath the LCD screen either results in an undesirably large device or greatly limits the size of the screen. Further, the device fails to disclose any means to edit or manipulate the images beyond simple annotations.

Other prior inventions address the issue of alphanumeric input, but fail to do so in the most efficient and desirable manner. Hsu, U.S. Patent Publication No. 2008/0024641 is directed to a digital image-taking device such as digital camera including a lens unit on one side and a screen and control panel located on the other. The control panel includes operation buttons. A character editing device is displayed on the screen or installed on the control panel, and allows editing of onboard text data. The character editing device has allows text characters to be branded on a displayed image. The characters and the digital photo can be saved in the memory card. The Hsu invention facilitates the annotation and branding of stored photos through an onboard or attached character editing device.

Similarly, Pavley, U.S. Pat. No. 6,370,282 is directed to a method and system for implementing efficient alphanumeric text entry for a portable digital electronic device. A first entry area and a second entry area are generated for display on the incorporated display screen of a digital electronic device. A cursor selects from among the various alphanumeric characters displayed in the first and second areas, as well as for highlighting. The movement of the cursor is controlled with the four-way controller built into the digital electronic device. The user controls the movement of the cursor among the alphanumeric characters within the first area and second area and controls the movement of the cursor between the first area and second area. A persistent selection highlight is generated for an alphanumeric character previously selected by the cursor. The user is able to process the currently selected alphanumeric character or the previously selected alphanumeric character in accordance with the user's actuation of an input control built into the digital electronic device.

The Hsu and Pavley devices address the issue of annotations, but fail to allow the user to input alphanumeric text in an efficient manner. The Hsu device requires either a stylus or the addition of an external keyboard or other labeling device. Such an external component is not likely to be useful at the time the picture is taken, as the user is unlikely to carry a keyboard with them at all times. While a stylus may be used, such components are typically easily lost frequently require the memorizations of complicated patterns to allow text input. A significant disadvantage of this system is the fact that it requires the use of a stylus and thus the inclusion of a touch screen in the digital camera. The stylus is an extra piece of hardware which must be maintained by the user (e.g., not be lost, broken, etc.). The touch screen is an expensive piece of hardware that must be included in each electronic device, increasing unit cost accordingly.

Alternatively, the Pavley invention allows branding and annotation of images using a selection wheel and an array of selectable letters. Such entry of text is cumbersome and may be bothersome to many users. In the case of the selection wheel method, using a graphically depicted selection wheel in conjunction with one or more buttons on the digital camera may not be particularly intuitive to practitioners. For example, the location of numerical characters on the selection screen with respect to the text characters may not be immediately obvious to a user. Typically, the numerical characters (numbers) are located either before or after the text characters (e.g., after the last alphabetical character “Z”). Further, once the numeric characters are accessed, often the manner in which individual numeric characters are accessed is counter intuitive. For example, whereas one soft key/button is used to “move” the selection wheel up or down to select text characters earlier or later in the alphabet, the same soft key/button could use multiple different schemes to access the numerical characters. Another problem is the fact that the user is required to traverse several steps in order to input text, which can make inputting large amounts of text (e.g., such as a meaningful description of a complex scene) tedious and frustrating.

Other devices have been optimized for use with digital videos. Senda, U.S. Pat. No. 6,912,005 is directed to an electronic camera recording and playback apparatus operable to both shoot a subject and edit shot data. The apparatus comprises a main unit and a display unit for displaying a shot image or an edited image. The display unit can be adjusted to a variety of viewing angles. The Senda invention provides an electronic video camera recording/playback apparatus that enables shooting and editing of shot data. The editing allows a few changes to be made to recorded video clips. The Senda device describes having a variety of editing functions for videos. Such functions would be significantly different from those required or desired for still photo editing.

The prior art devices each suffer from one or more flaws necessitating the need for improvement in the art. Prior art devices that include a keyboard, suffer from size and practicality issues, whereas devices that do not include a keyboard suffer from usability issues. Thus, there is a need for a way of entering text into a digital camera, as well as performing editing functions that is intuitive and efficient. The required method should offer a user-friendly method of entering text even though the display of the handheld device may be quite small. The present invention provides a novel solution for the above requirements. The present invention improves the current prior art by providing a digital camera containing a flip-out keyboard in order to facilitate compact, portable construction. The device makes use of a keyboard, pointing device and editing software functions to annotate and otherwise edit the stored digital photos. Further, the practitioner may have the option to leave pictures blank or unedited, add text of varying fonts and colors to any desired locations or perform other edit functions on the stored digital photographs. The present invention substantially diverges in design elements from the prior art and fills a long felt need in the art.

### SUMMARY OF THE INVENTION

In view of the foregoing disadvantages inherent in the known types of digital picture cameras now present in the prior art, the present invention provides a new means of taking photographs wherein the same can be utilized for providing convenience for the user when editing and annotating digital images immediately after being taken.

The primary object of the present invention is to provide a character-editing device integrated with a digital camera device. The character-editing device is able to brand characters onto the image as it is displayed on the screen and save the image together with the characters to the memory card.

It is a further object of the present invention to provide a new and improved digital camera and photo editing device that has all of the advantages of the prior art and none of the disadvantages.

Another object of the present invention is to provide a digital camera with means for editing previously taken and stored digital photographs. Further, said editing will including annotating, as well as other desirable functions such as cropping, color manipulation, and touch-ups.

Yet another object of the present invention is to provide a method for editing, manipulating and annotating photographs stored digitally on the memory of a digital camera.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention alongside an annotated photograph.

FIG. 2 shows a perspective view of the present invention in use, with the LCD screen fully extended to expose the keyboard beneath.

### DETAILED DESCRIPTION OF THE INVENTION

Reference is made herein to the attached drawings. Like reference numerals are used throughout the drawings to depict like or similar elements of the character-editing photograph device. For the purposes of presenting a brief and clear description of the present invention, the preferred embodiment will be discussed as used for digital photography and the manipulation of digitally stored photographs. The figures are intended for representative purposes only and should not be considered to be limiting in any respect.

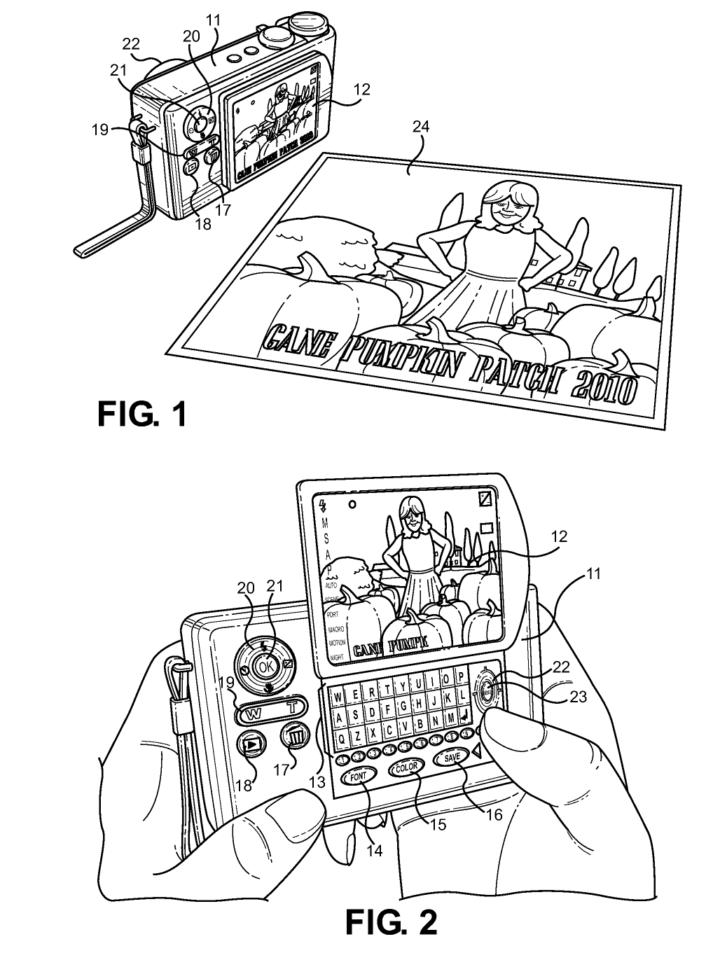

Referring now to FIG. 1, there is shown a perspective view of the present invention alongside an annotated and branded photograph. The back face of the present invention 11 is oriented to show the LCD display screen 12. Shown on the display screen is a digitally stored photograph, which has been selected for editing or review. A printed version of the annotated photograph 24 is located next to the device 11. A lens 22 is located on the front of the device 11 to capture images. Further, photo capture control buttons are located on the back of the device 11, adjacent to the LCD screen 12. A photo option control 20 and selection button 21 allow the user to select a variety of options and settings for photo capturing. A telephoto and wide-angle button 19 allows the practioner to zoom in and out as desired. Further display 18 and delete buttons 19 allow the user to display recently taken pictures and delete them if so desired.

Referring now to FIG. 2, there is shown a perspective view of the present invention in use, with the LCD display screen 12 fully extended to expose the keyboard 13 beneath. The back face of the present invention contains several buttons to allow the user to adjust a variety of settings to capture photos in an ideal and desired manner. There is a photo option control 20 and selection button 21, a telephoto and wide-angle button 19, display 18 and delete buttons 19 allow the user to display recently taken pictures and delete them if so desired. Sliding the LCD display screen 12 upward reveals a full alphanumeric keyboard 13. Further, a variety of buttons to assist in editing may be included as well, such as a font selection button 14, a color selection button 15 and a save button 16. The font selection button 13 will allow the practitioner to select a desired font for branding from those available. The color selection button 15 allows the practitioner to select the desired color for the font for branding into the displayed photograph. Further, the color selection button may be used to select color with any other editing function included with the device. The save button allows the edits by the user to be saved to the memory card of the digital camera. Located proximally to the keyboard 13 is a cursor directional button 23 and cursor selection button 23, which may be used to perform a variety of editing tasks. The cursor directional button 22 directs a cursor on the LCD display screen 12, while the cursor selection button 23 can be used to select the subject at which the cursor is pointing. The cursor may be used to perform a variety of editing tasks, such as selecting areas for cropping or choosing the location of branded text.

The present invention is a novel improvement upon a standard digital camera device. In use, an individual will use the device to take digital photographs as desired. As with a traditional digital camera, a lens 22 mounted to the front of the present invention captures the desired photograph. Picture taking options are available through a variety of controls such as a photo option control 20 and selection button 21, a telephoto and wide-angle button 19, a display 18 and delete buttons 19. Once digital photos are captured, the editing software included in the device may be used to alter stored photos.

In particular, the editing software focuses on the annotating and branding of the photographs, but also facilitates other editing options. Following a successful photo capture, the LCD display screen may be slid upward to reveal the full keyboard 13 and cursor directional control 22 for editing. Practitioners may use the keyboard 13 to input text for branding to the digital photograph. Further, the practitioner may select the font using the font selection button 14 and the color of the text using the color selection button 15. The user may select the location of the branding using the cursor, with the cursor directional control 22 and the cursor selection button 23. The user may also perform a variety of editing functions through a combination of keyboard and cursor usage such as cropping, filtering and other photographic touch-ups. The photographs may be saved in edited or original form the memory within the camera at any time.

In an alternative embodiment, the LCD display screen 12 may be replaced with a touch screen for increased editing efficiency. Inclusion of a touch screen would allow the practitioner to more directly select and manipulate the photographs. Such a touch screen could allow the user manipulate the cursor with their fingertips, as well as allowing the implementation of a variety of soft keys to assist in the editing process.

The present invention is designed to allow individuals to recall specific events and accurately identify times and places captured in photographs through annotation, branding and editing of digital photographs.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A digital image-taking device comprising:
an apparatus having a slidable display screen on one side thereof with photo control and operations buttons located beside said screen;
said slidable display screen being capable of sliding;
an alphanumeric keyboard and editing controls located beneath said slidable display screen;
and said editing controls having an editing feature to brand characters onto a digital photo currently displayed on said screen, and to save said photo and characters to a memory card.

2) Said digital image-taking device as described in claim 1, further comprising a movable pointer displayed on said screen controllable by a cursor directional control button and selection button.

3) A digital image-taking device as described in claim 1, further comprising software capable of cropping, zooming, filtering, altering colors and shading said photographs.

4) A digital image-taking device as described in claim 1, in which said slidable display screen is a touch screen, capable of assisting said editing functions.

5) A method for efficiently editing a stored digital photo through an interface on a digital camera device, the method comprising the steps of:
a) selecting the stored photo from a memory card of a digital camera device for display;
b) choosing an editing operation to be performed on said selected photo;
c) controlling a cursor using directional and selection buttons to perform editing operations to said selected stored photo;
d) saving said edited photo.

6) A method as in claim 5, in which the editing operation chosen comprises branding alphanumeric characters on a chosen location of said selected stored photo.
